(19) United States
(12) Patent Application Publication
(10) Pub. No.: US 2011/0028091 A1
(43) Pub. Date: Feb. 3, 2011

(54) METHOD AND SYSTEM FOR NEAR-FIELD WIRELESS DEVICE PAIRING

(75) Inventors: ROBERT J. HIGGINS, PLANTATION, FL (US); GEORGE S. HANNA, MIAMI, FL (US); JOHN B. PRESTON, PLANTATION, FL (US); DANIEL A. TEALDI, PLANTATION, FL (US)

Correspondence Address: MOTOROLA, INC.;Penny Tomko, 1303 EAST ALGONQUIN ROAD, IL01/3RD, SCHAUMBURG, IL, 60196, US

(73) Assignee: MOTOROLA, INC., SCHAUMBURG, IL (US)

(21) Appl. No.: 12/534,246

(22) Filed: Aug. 3, 2009

(51) Int. Cl. H04B 7/00

(52) U.S. Cl. 455/41.2

(57) ABSTRACT

A first communication device (e.g., a radio) and a second communication device (e.g., an accessory) implement a wireless device pairing procedure to exchange numerical credentials so that the devices can subsequently form a link for communications using electromagnetic radio signals. The accessory transmits a beacon comprises a pairing request. Upon a user bringing the radio and accessory in close enough proximity, the radio receives the beacon using near-field apparatus included in the radio. In response to receiving the beacon, the radio initiates a pairing procedure, wherein the pairing procedure comprises a data exchange between the radio and accessory, and wherein the beacon and the data exchange comprise a non-propagating radio signal generated using the near-field apparatus. Upon completing the pairing procedure, the radio forms a link with the accessory to communicate using propagating electromagnetic radio signals.

### TECHNICAL FIELD

The technical field relates generally to wireless device pairing and more particularly to wireless device pairing using a non-propagating radio signal.

### BACKGROUND

In some communication scenarios, it is desirable to have secure wireless device pairing, for instance pairing of a radio with a peripheral device when the radio and the peripheral implement a wireless protocol, such as Bluetooth, which requires the utilization of a propagating, i.e., electromagnetic, radio signal to send data. One example scenario where such secure wireless device pairing is desired is in the area of Public Safety. More particularly, Public Safety officers may select radios that implement the Bluetooth protocol from a pool of radios in a multi-unit charger and pair their own wireless accessories with the selected radio; and this accessory pairing procedure may occur in the presence of many officers doing the same. Further compounding the problem, a majority of the radios being used in public safety have no keypad, display, or other graphical user interface (GUI). Moreover, even where a radio does have a GUI, many aftermarket accessory additions of wireless technology provide no access to the radio's GUI. Thus, for some radios, a very limited user interface or even no user interface is present to facilitate the pairing procedure.

Known pairing technologies have shortcomings in providing secure wireless device pairing, especially for radios having no GUI or a very limited GUI. For example, several wireless communication standards, such as Bluetooth and IEEE (Institute of Electrical and Electronics Engineering) 802.11b/g, contain a mechanism for device pairing. These mechanisms involve a user typing a series of symbols (e.g., a PIN, for example decimal digits for Bluetooth and hexadecimal or ASCII characters for IEEE's 802.11b's Wireless Equivalent Privacy (WEP) protocol) to validate that the user is pairing the correct accessory, which is incompatible with radios that have no keypad. More particularly with respect to Bluetooth technology, the Bluetooth SIG (Special Interest Group) developed for the 2.1 Bluetooth specification a way to do “secure simple pairing” (SSP) using public key cryptography. Generally, this SSP requires a numeric verification, and is incompatible with devices that have no display. There is a “just works” mode for the SSP, but this suffers from “man in the middle” vulnerability. In cryptography, the man-in-the-middle attack (often abbreviated MITM), or bucket-brigade attack, or sometimes Janus attack, is a form of active eavesdropping in which the attacker makes independent connections with the victims and relays messages between them, making them believe that they are talking directly to each other over a private connection when in fact the entire conversation is controlled by the attacker. There is also an “out of band” (OOB) methodology stated, that could be used, but it is complex and requires heavy computation (actually all of SSP requires heavy computation) and creates pairing delay. In the end, the SSP is not as simple or as secure as desired for users needing secure communications such as Public Safety customers.

With respect to an OOB methodology for devices utilizing the Bluetooth protocol, it has been proposed that pairing between host and peripheral devices can be facilitated using “Near Field Communication (NFC)” OOB technology. However, a known implementation of NFC in device pairing: requires an initial discovery and authentication procedure utilizing propagating electromagnetic radio waves, which subjects the resulting link to hacking; requires a display and a keypad on the host device for a user to initiate the pairing procedure (such as through the use of a menu) and for the user to select a peripheral for pairing; uses a protocol proposed in “Near Field Communication (NFC) Interface and Protocol” (NFCIP-1) by EMCA that transmits at 13.56 MHz utilizing a passive tag in the peripheral that requires a high power carrier from the host device to initiate the tag and to enable the tag to transmit stored identification data; and requires a button on the radio for the user to accept the pairing at the completion of the pairing procedure data exchange.

It addition, even though cell phones are equipped with a highly evolved GUI, customers still had substantial problems using Bluetooth's built in pairing security procedure—use of a PIN. More particularly, the use of the PINs proved to be such a problem that the cellular community “standardized” the PINs as 0000 or 1234 in order to effectively automate the PIN security out of the pairing process. This eased the pairing problems customers were experiencing but also opened the devices to hacking, and there were many reports of such hacking in the literature and news media.

Thus, there exists a need for a method and system for wireless device pairing that addresses at least some of the shortcomings of past and present wireless device pairing techniques and/or mechanisms.

### BRIEF DESCRIPTION OF THE FIGURES

The accompanying figures, where like reference numerals refer to identical or functionally similar elements throughout the separate views, which together with the detailed description below are incorporated in and form part of the specification and serve to further illustrate various embodiments of concepts that include the claimed invention, and to explain various principles and advantages of those embodiments.

FIG. 1 is a block diagram illustrating a system that includes a radio and accessory that implement wireless device pairing in accordance with some embodiments.

FIG. 2 is a pictorial diagram of the system of FIG. 1 showing the resonant antennas used to implement wireless device pairing in accordance with some embodiments.

FIG. 3 illustrates a circuit diagram of near-field communication apparatus in accordance with some embodiments.

FIG. 4 illustrates a message sequence chart (MSC) showing a method for wireless device pairing in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments. In addition, the description and drawings do not necessarily require the order illustrated. It will be further appreciated that certain actions and/or steps may be described or depicted in a particular order of occurrence while those skilled in the art will understand that such specificity with respect to sequence is not actually required. Apparatus and method components have been represented where appropriate by conventional symbols in the drawings, showing only those specific details that are pertinent to understanding the various embodiments so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

### DETAILED DESCRIPTION

Generally speaking, pursuant to the various embodiments, a first communication device, e.g., a radio, and a second communication device, e.g., an accessory, implement a wireless device pairing procedure using an out of band (OOB) signal to exchange numerical credentials so that the devices can subsequently form a link for communications using electromagnetic radio signals. The accessory transmits a beacon, wherein the beacon comprises a pairing request. Upon a user bringing the radio and the accessory in close enough proximity, the radio receives the beacon using near-field apparatus included in the radio. In response to receiving the beacon, the radio initiates a pairing procedure and confirms the accessory as being a trusted device, wherein the pairing procedure comprises a data exchange between the radio and accessory, and wherein the beacon and the data exchange comprise a non-propagating radio signal generated using the near-field apparatus, wherein the non-propagating radio signal in one embodiment comprises a modulated carrier signal centered at about 125 kHz and consists substantially of a magnetic component. Upon completing of the pairing procedure, the radio forms a link with the accessory to communicate using propagating electromagnetic radio signals.

Benefits of implementing the disclosed embodiments include: the only user input is bringing and maintaining the two communication devices in close enough proximity for the host device to receive the beacon from the peripheral, which is compatible even with radios having no display, keyboard, or other GUI; the low frequency non-propagating signal is easy to generate and supplies close range communications at low power (the prior art NFC OOB technique implemented at 13.56 MHz requires 100× more receive power (e.g., 15-20 mW) and cannot, therefore, be left active in a battery powered product); the low frequency non-propagating signal penetrates the radio and plastic housings with internal antennas not requiring any opening in the plastic that could leak; the low frequency non-propagating signal is so far below the frequencies for the electromagnetic signals used in most of the radios that interference with the radios is minimized or non-existent; the near-field communications are fundamentally secure because the propagation law for this technology is 1/r⁶ instead of 1/r² for normal propagating radio signals—basically, after a short distance the signal strength falls so steeply as to be below the thermal noise floor and is thus hidden from surreptitious reception, which also enables the secure communications and further enables unambiguous pairing (a user knows exactly which peripheral is paired), which is compatible with the above-described “squad room scenario” where many officers are in close proximity while paring their devices. Those skilled in the art will realize that the above recognized advantages and other advantages described herein are merely illustrative and are not meant to be a complete rendering of all of the advantages of the various embodiments.

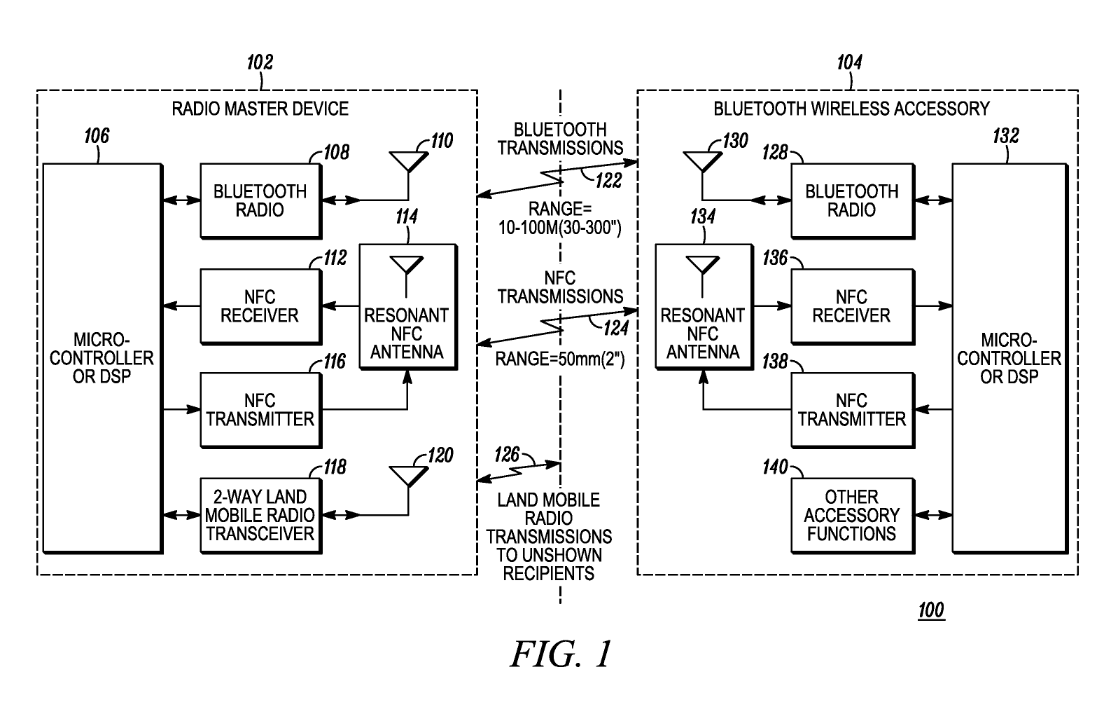

Referring now to the drawings, and in particular FIG. 1, a block diagram illustrating a system that includes two devices that implement wireless device pairing in accordance with some embodiments is shown and indicated generally at 100. System 100 includes a first communication device 102 (in this case a radio “master” device) and a second communication device 104 (in this case a Bluetooth wireless accessory “slave” device). The first and second communication devices can be any type of communication devices operated by a user for which wireless device pairing is needed. For example, the first (master) communication device is the device that receives a beacon (as described in more detail below) from the second (slave or peripheral) communication device, wherein the first and second communication devices can be any type of wireless communication device that operates over one or more “in-band” frequencies that use a propagating signal (also referred to in the art as a radiating signal and an electromagnetic signal). Moreover, the master device is equipped with apparatus for transmitting and receiving media such as voice, data, and video. Accordingly, device 102 can be, but is not limited to, a land or mobile radio, a cellular telephone, a personal data assistant (PDA), a personal computer, and the like. Device 104 (the peripheral device) can be, but is not limited to, an accessory such as an earpiece or headset, etc., but could also be equipped with apparatus for transmitting and receiving media and/or configured for other functionality.

A propagating signal is defined as an electromagnetic signal comprising both electric and magnetic field components that is generated by supplying a radio frequency alternating current to an antenna at a transmitting device to generate a signal that self-propagates (i.e., a radiating wave), such that the signal can be successfully received at an antenna at a receiving device at distances of well over six inches. A propagating signal obeys a 1/r² propagating law in unobstructed environments, wherein the signal falls off at a rate of about 1/r² where r is the distance between the transmitting and receiving antennas. Contrast this to a non-propagating signal (also referred to in the art as an evanescent signal) that is defined as a signal having a substantially magnetic field component or a substantially electrical field component but not both, which obeys a 1/r⁶ propagating law, wherein the non-propagating radio signal power falls off at a rate of about 1/r⁶ where r is the distance between the transmitting and receiving antennas. Accordingly, a non-propagating signal is localized to its source by lack of an antenna that can produce a radiating wave. Instead, the antenna used to generate a non-propagating signal is so electrically small compared to the wavelength of the exciting signal so as to produce no substantial electromagnetic component but only a local electric or magnetic field in the vicinity of the antenna (the non-propagating component of the signal is on the order of 10⁶ times as big as any propagating component of the signal, if one is present). Thus, a non-propagating signal cannot be successfully received at distances between the transmitting and receiving antennas of more than six inches with an antenna smaller than 2″ or more than 36″ with even a very large (14″ inch square) antenna such as an attacker might employ.

Turning back to the description of system 100 of FIG. 1, device 102 comprises: a microcontroller or digital signal processor (DSP) 106; apparatus for shorter range communications 122 (e.g., 10-100 m or 30-300′) using electromagnetic signals, which in this case is Bluetooth apparatus that includes a Bluetooth radio 108 with a corresponding antenna 110; near-field communication (NFC) apparatus (or simply near-field apparatus) that includes an NFC receiver 112, a resonant NFC antenna 114, and an NFC transmitter 116; and a two-way land mobile radio transceiver 118 with a corresponding antenna 120. Device 104 comprises: a microcontroller or DSP 132; corresponding Bluetooth apparatus that includes a Bluetooth radio 128 with a corresponding antenna 130; corresponding near-field apparatus that includes an NFC receiver 136, a resonant NFC antenna 134, and an NFC transmitter 138; and other accessory functions 140.

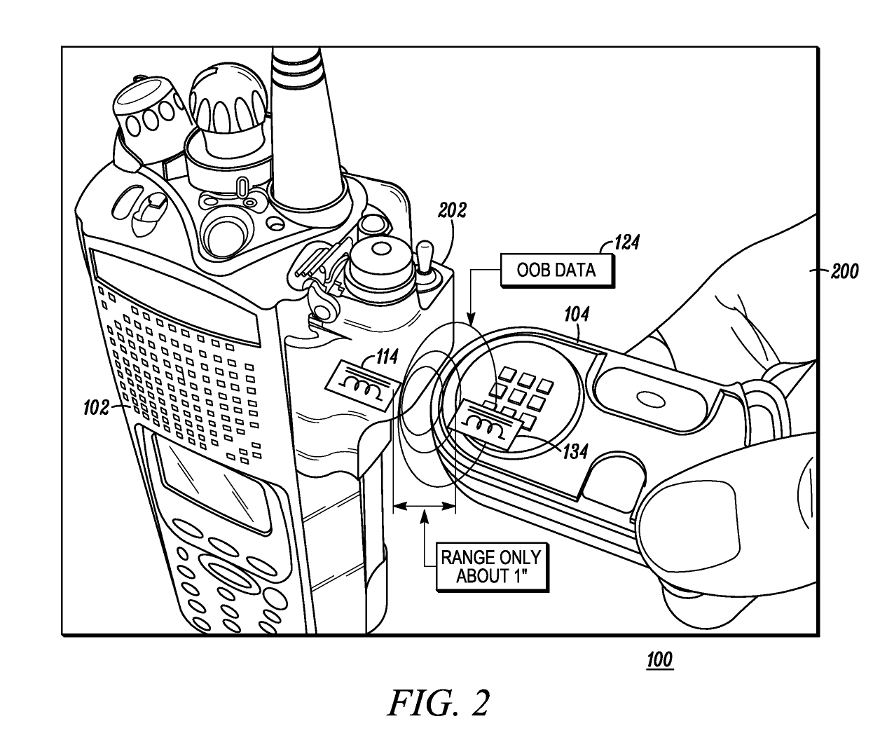

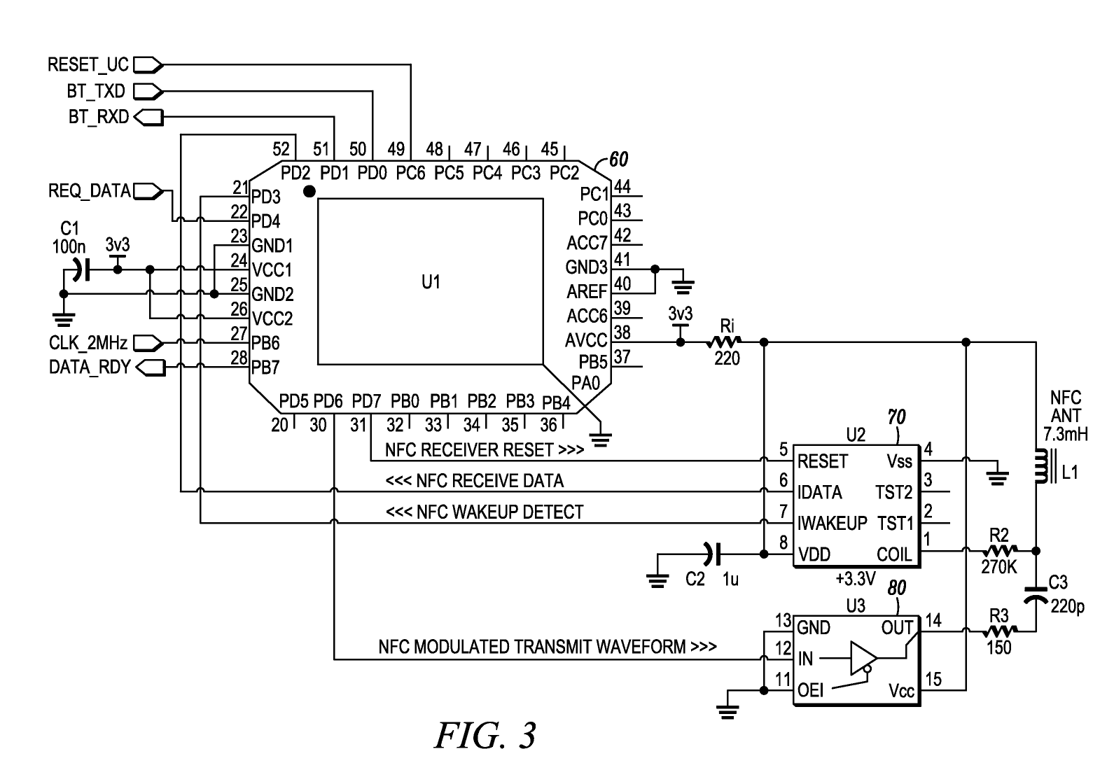

In accordance with the teachings herein, upon a user powering ON peripheral 104, it generates and transmits a beacon using the near-field apparatus 134, 138, wherein the beacon itself is a pairing request. Then upon the user bringing the peripheral close enough (e.g., six inches or less, and in one embodiment two inches (50 mm) or less) to the radio 102 for the radio to receive the beacon using the near-field apparatus 112, 114, the radio controller 106 initiates a pairing procedure with the accessory 104, wherein data is exchanged using the near-field apparatus in devices 102 and 104 in order to authenticate both devices, confirm that the accessory is a trusted device that is authorized to be paired with the radio 102, and exchange numerical credentials for pairing. FIG. 2 is a pictorial diagram of system 100 showing a user 200 bringing the accessory (104) within about one inch from the radio 102 to initiate the pairing procedure between the two devices. The OOB data 124, e.g., the beacon and the pairing data exchange, comprises a non-propagating signal that is localized around the resonant antennas 114 (shown as being included in an adaptor 202 on the radio 102) and 134 (in the accessory 104). With the components used in the near-field apparatus described below by reference to FIG. 3, the range between the near-field apparatus in the host and peripheral is about 2″ from antenna to antenna, which leaves enough room for embedding the antennas on the boards within the accessory and within the radio and some room to spare (e.g., the 1 inch) on the outside.

Once the radio 102 and the accessory 104 store their respective numerical credentials for pairing, the devices are “paired”, and controllers 106 and 132, respectively, control the Bluetooth radios 108 and 128 to establish a link for the Bluetooth transmissions 122 such as voice transmission between the accessory 104 (e.g., an earpiece) and the radio 102. The Bluetooth radios 108 and 128 comprise conventional Bluetooth transceivers that implement the Bluetooth protocol in accordance with any one or more of: Bluetooth Specifications 1.1 ratified as IEEE Standard 802.15.1-2002; Bluetooth Specification 1.2 ratified as IEEE Standard 802.15.1-2005; Bluetooth Specification 2.0+EDR (Enhanced Data Rate) released on Nov. 10, 2004; Bluetooth Core Specification 2.1 adopted by the Bluetooth SIG on Jul. 26, 2007; Bluetooth Specification 3.0 adopted by the Bluetooth SIG on Apr. 21, 2009; and/or subsequent Bluetooth Specification releases. In this embodiment, Bluetooth technology is used for the short-range communications, but any suitable technology can be used for the short-range communications including, but not limited to, Zigbee, IEEE 802.11 a/b/g (Wi-Fi), Wireless USB, etc.

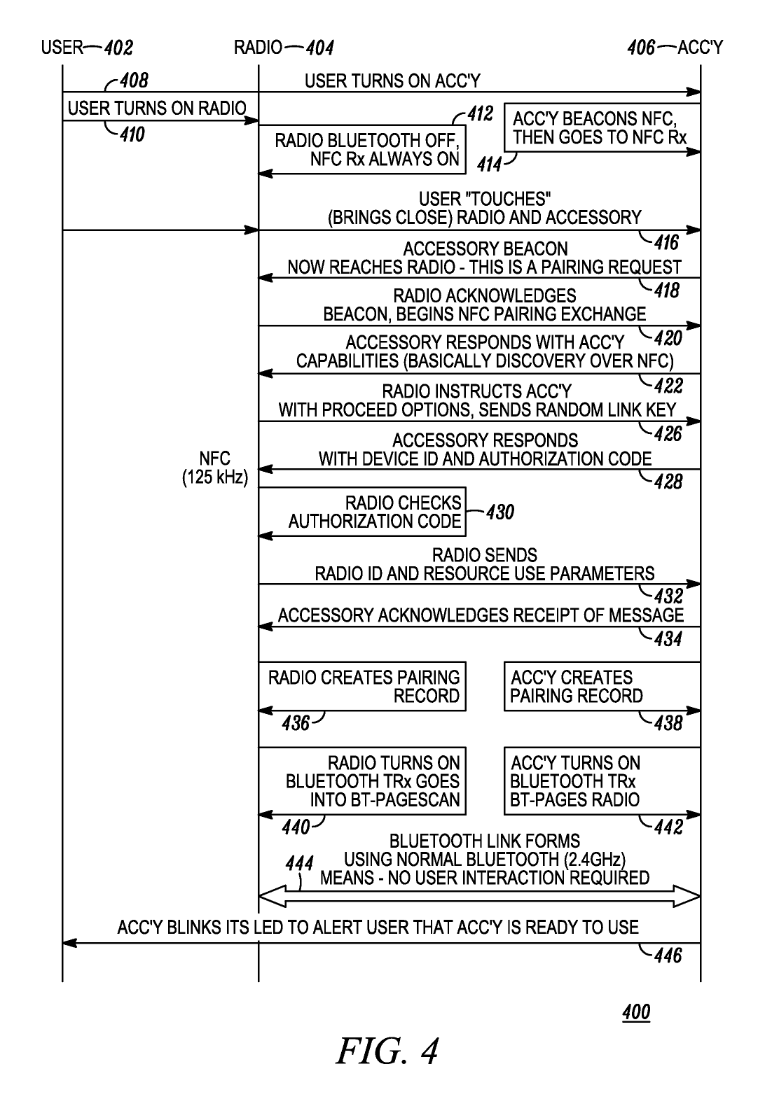

The near-field apparatus in both devices 102 and 104 is described in detail below by reference to FIG. 3, and the operation of the near-field apparatus to affect wireless device pairing in accordance with the teachings herein is described by reference to the message sequence chart (MSC) illustrated in FIG. 4. With further respect to device 102, transceiver 118 and antenna 120 are also conventional elements that, in this illustrative embodiment, implement one or more protocols that enable the transmission and reception of two-way voice media 126 over the air with other communication devices (not shown). Such protocols may include, but are not limited to, standards specifications for wireless communications developed by standards bodies such as TIA (Telecommunications Industry Association), OMA (Open Mobile Alliance), 3GPP (3rd Generation Partnership Project), 3GPP2 (3rd Generation Partnership Project 2), IEEE (Institute of Electrical and Electronics Engineers) 802, and WiMAX Forum. Moreover, controller 106 controls the coordination of the Bluetooth apparatus, the near-field apparatus, and the two-way radio transceiver apparatus for effectuating the corresponding communications using the respective apparatus.

With further respect to device 104, the other accessory functions 140 may include, but are not limited to, headsets, car audio kits, text display and keyboard devices, handheld computing devices, scanners, printers, and remote control devices. In addition, controller 132 controls the coordination of the Bluetooth apparatus, the near-field apparatus, and the other accessory functions for effectuating the corresponding communications using the respective apparatus.

Turning now to FIG. 3, a circuit diagram of a near-field communication apparatus in accordance with some embodiments is shown and generally indicated at 300. Near-field apparatus 300 can be implemented in both the radio 102 and the accessory 104 for data communications between “peer” self-powered devices (as opposed to one device being a passive device, which is not self-powered, as in the case of prior art NFC communication) via a low frequency evanescent carrier wave; and communications with the Bluetooth subsystem (e.g., apparatus 108, 110 and 128, 132 in the radio 102 and accessory 104, respectively) via a logical data pipe such as an asynchronous serial data connection. Apparatus 300 comprises primary components of: a microcontroller U1 (60) having pins 21 through 52, which performs the functionality of transmitter 116 or 138 of FIG. 1; a low frequency receiver U2 (70) having pins 1 through 8, which performs the functionality of receiver 112 or 136 of FIG. 1; a high speed CMOS (complimentary metal oxide semiconductor) buffer U3 (80) having pins 11-15; and a resonant antenna assembly comprising a resistor R2 having a value of 270K ohms, a resistor R3 having a value of 150 ohms, a coil device that in this case is an inductor L1 having a value of 7.3 millihenry, an antenna resonating capacitor C3 having a value of 220 picofarads, and a bypass capacitor C2 having a value of 1.0 microfarad, which performs the functionality of antenna 114 or 134 of FIG. 1.

In this illustrative embodiment, microcontroller U1 is a general purpose microcontroller having programmable function input/output (GPIO) device pins comprising a pairing protocol controller, a serial data decoder, and a modulated data transmitter (not shown) that are logical functions implemented in software in the microcontroller. Microcontroller U1 is programmed with software (code) to receive, via pins 21 and 52, serial data input from pins 7 and 6, respectively, of the low frequency receiver U2; and to receive data, via pin 50, from the Bluetooth subsystem. Microcontroller U1 is further programmed with software to transmit data, via pin 51, to the Bluetooth subsystem; and to transmit data, via pin 30, through buffer U3 and the resonant antenna assembly to another peer low frequency near-field system. Microcontroller U1 is programmed with software to receive data and to generate and transmit data according to a pre-established pairing protocol as illustrated by the MSC shown in FIG. 4.

Operation of system 300 is best described by means of an example data transaction between apparatus 300 and similar near-field apparatus in another device. This illustrative data transaction and the corresponding operation of system 300 are described by reference to system 300 residing in a host device. Upon initial application of power to the host from a battery, microcontroller U1 is turned ON and communicates with the Bluetooth subsystem over a serial data pipe (U1 pins 50 and 51) to retrieve a numerical pairing credential record representing the Bluetooth system. This numerical pairing record includes an identification indication for the Bluetooth subsystem such a Bluetooth address (BDADDR).

Microcontroller U1's pin 30 (PD6) is initialized to a static logic high output to set the resonant antenna circuit (L1, C3) to a receive mode; and microcontroller U1 sends a brief positive going reset pulse on output pin 31 (PD7) to reset receiver U2 (at pin 5) into a state where it is listening for a transmission from another near-field peer unit. When receiver U2 detects a carrier broadcast from a peer peripheral device, receiver U2 pulls its !WAKEUP output pin 7 low, which signals microcontroller U1 on its input pin 21 (PD3) that data may be arriving from receiver U2. Receiver U2 now places any received data bits that it demodulates onto its !DATA output pin 6, which is accepted by microcontroller U1 at input pin 52 (PD2). Microcontroller U1 decodes the incoming serial data on PD2 (with its software application) and determines that an external unit has begun a pairing sequence according to the pre-established pairing protocol.

Microcontroller U1 transmits data messages according to the pre-established pairing protocol to the peer by creating a modulated low frequency evanescent wave (also referred to as a non-propagating radio signal). Transmission is achieved by connecting an internal low frequency oscillator inside of microcontroller U1 (such as a free running timer) intermittently to output pin 30 (PD6) (when not connected to the low frequency internal oscillator, PD6 is logic high output) so as to create a serial succession of oscillator bursts with interstitial logic high at PD6 to form the modulated data transmit waveform. This, thereby, generates a modulated carrier signal that is centered at about the oscillator frequency, for example 125 kHz, wherein the spectral content of the modulated data signal is confined to remain within the transmission frequency bandwidth of the near-field antenna. Moreover, the non-propagating signal can be centered around any suitable “low” frequency, wherein low frequency refers to frequencies of less than 1 MHz. The particular frequency depends on the constraints of the parts selected to build the near-field apparatus; and in particular where a microprocessor is used, the center frequency depends on the frequency of the clock in the microprocessor that is used to synthesize the carrier signal. Having such a low frequency signal also guards against the near-field signal interfering with the other media transmissions by the radio.

This modulated data transmit waveform is applied to transmit buffer U3, which drives the series resonant antenna circuit comprised of R2, R3, L1, C3, and bypass capacitor C2. This antenna is designed to have a series resonance at the frequency of the internal low frequency oscillator in microprocessor U1 (in this case 125 kHz). At the resonant frequency of the antenna, the impedance seen by the output of buffer U3 is the resistive residue of the reactive elements plus the resistance of R3, which is used to control the transmission frequency bandwidth of the antenna. The logic swing at the output of U3, Vₜₓ, is typically 3.3V peak-to-peak. Vₜₓ causes a peak-to-peak current swing, Iₜₓ, in L1 of Vₜₓ divided by the total resonant antenna resistive residue plus R3. A typical peak-to-peak low frequency carrier current, flowing in L1 is 5 milliamperes peak-to-peak. When this resonant alternating current is flowing through L1, L1 creates a surrounding non-propagating radio signal comprising a modulated carrier signal centered at about the frequency of the internal low frequency oscillator in the microprocessor U1 and consisting substantially of a magnetic field component, which can be detected remotely by the peer device when it is within a very short range.

Microcontroller U1 communicates data to and from the remote peer device according to the pre-established pairing protocol (e.g., in accordance with the MSC in FIG. 4), and, in the process, exchanges numerical pairing credential records. The peer device's numerical pairing credential is sent via the serial data pipe (U1 pins 50 and 51) to the Bluetooth subsystem. Upon receiving the completed and valid numerical pairing record, the Bluetooth subsystem has the information needed to form a Bluetooth link and it establishes a Bluetooth link with the peer device using, for example, a standard Bluetooth Page operation.

The peripheral device also contains near-field apparatus 300, which operates in a similar manner as described above. Upon initial application of power to the peripheral from a battery, microcontroller U1 is turned ON and communicates with the Bluetooth subsystem over the serial data pipe to retrieve a numerical pairing credential record representing the Bluetooth system. The microcontroller then alternatively generates and transmits its non-propagating beacon signal (in the manner described above for transmitting a data signal) to request pairing with a host device and then listens for a transmission from the host device. Once it detects the non-propagating wave from the host device, the microprocessor U1 in the peripheral engages in the near-field data exchange with the host device near-field apparatus in accordance with the microprocessor U1 programming.

The following comparison between the operation of near-field apparatus 300 and the prior art NFC apparatus at 13.56 MHz will demonstrate beneficial and unexpected results from using apparatus 300. As described above, the near-field apparatus 300 uses non-radiating “antennas”, which are so electrically small as to provide no substantial propagating component, but only a magnetic field in their vicinity. This local field falls off quite rapidly with distance, typically r⁻⁶, where r is the distance between the non-propagating near-field antennas. The result is that when the signal strength is adjusted for the desired NFC communications range, by the time you get to twice that range, the signal is 2⁻⁶ smaller or 1/64 the level.

Lets say the transmit signal strength is set up for 2″ of reliable range by adjusting the transmit current in the coil. When the device is separated to 4″, the signal strength has fallen to 1/64 of that seen at 2″ and is probably not receivable. By 8″ of distance, the signal is 4⁻⁶ or 1/4096 and is definitely not receivable. So at close range, there can be plenty of signal, but it dies off so quickly with distance that it quickly becomes unreceivable. This is fundamentally advantageous for security and to insure that the pairing is unambiguous (the user knows exactly what devices were just paired) because it is unlikely that another device will be within that small 2″ range. Moreover, since any unsecured data is transmitted via a non-propagating signal at this short range, it is unlikely to be intercepted. Contrast this to the prior art NFC implementation at 13.56 MHz where some unsecured data is initially transmitted via a Bluetooth propagating signal that could possibly be intercepted.

In addition, the near-field apparatus can operate when the Bluetooth apparatus is turned OFF and, thereby, not drawing power from the battery to transmit and receive data; and even when actively receiving data, near-field apparatus 300 draws only about 12 uW of power and less in standby mode. To put this drain in perspective, a 2032 lithium coin cell would power this IC in active mode for 25 years. This low power drain allows the near-field receiver in apparatus 300 to be operated continuously while drawing the minimal power until it detects a carrier from another device, which enables the device pairing to occur with the only user input being powering the two devices and bringing the devices close enough together for the host device to receive the beacon pairing requests from the peripheral device. Such operation is compatible even with host devices and peripherals having no display or other GUI, and not even a press of a button is requires to start the pairing procedures once the devices are powered on. Moreover, in one implementation, the pairing apparatus in the peripheral is only active before and during a pairing procedure, and the beacon transmission is only intermittent in bursts. Once the device is paired, the apparatus 300 discontinues transmitting the beacon to save power in the accessory and to avoid unnecessary contamination of the radio spectrum.

By contrast, prior art NFC systems are designed to read persistent information from a device (a tag; AKA “RFID”) that has no power source of its own. The use case is that the tag is programmed with a data record and can be read by an NFC reader. The reader powers the passive tag by supplying a strong RF carrier so that the tag can transmit back its data record. Passive tags are desirable because they can be an inexpensive solution without having a battery, which will last for years. More particularly, the reader transmits a high level carrier, often 200 to 1000 milliwatts, typically with an ASK modulation (low modulation depth). The tag receives the carrier and converts its energy into a DC power source to supply the tag's circuitry—incident carrier power must be strong to supply power for operating the tag. The tag creates a subcarrier on the incident carrier of ±847.5 kHz and modulates the subcarrier with the data record stored in the tag memory. The tag reader receives this subcarrier and demodulates the data to recover the data record sent back by the tag. Achieving even a short range means supplying lots of power to the reader's transmitter coil—generally 200-1000 milliwatts, which is many times greater than the power drain (12 uW) from apparatus 300.

Returning to implementation detail of near-field apparatus 300, it is also possible to have microcontroller U1 (60) generate a separate continuous carrier signal and output it on one of its GPIO pins, and supply the data to modulate this carrier on a separate output GPIO pin. This might be advantageous if the microcontroller contains an internal hardware logic peripheral useful for managing the output of serial data. In such a case, buffer U3 in FIG. 3 could be replaced with a 2-input logic gate such as an AND, OR, NAND, or NOR gate to be used to combine the carrier output signal and the serial data signal to provide a serial data transmit waveform equivalent to that which was created in software in the previous description of the preferred embodiment.

Turning now to FIG. 4, a message sequence chart illustrating a method for wireless device pairing in accordance with some embodiments is shown and generally indicated at 400. MSC 400 shows the message sequences between a radio 404 and an accessory 406 of a user 402. At 408 and 410, the user turns on, respectively, the accessory and the radio. In this embodiment, the radio Bluetooth apparatus is turned OFF, but the radio near-field apparatus is continuously receiving, 412. The accessory intermittently transmits a beacon (a non-propagating signal burst sequence centered at around 125 kHz) using the near-field apparatus and then sets itself to receive mode using the near-field apparatus, 414. When, the user touches or brings the radio and accessory within close enough proximity (in general six inches or less and in this specific illustrative example two inches or less), 416, the accessory beacon now reaches the radio, 418, which comprises the pairing request.

In one embodiment, each data transaction (including the beacon and the data exchange during the pairing procedure) is sent in UART (Universal Asynchronous Receiver/Transmitter) format 8N1 at 1200 baud, and in one implementation, the transmitted beacon has two bytes: 0x00 (=0b00000000) to wake up the near-field microprocessor U1 in the host; and 0xAA (=0b10101010), wherein a 0 bit is a bit time of 125 kHz carrier transmission, and a 1 is an empty bit time (no carrier).

Upon the radio's near-field receiver detecting the accessory's beacon, the radio's near-field receiver responds immediately thereafter with a bi-directional data exchange 420 through 434 to setup the Bluetooth pairing without the Bluetooth radio even being active. In an embodiment, the radio acknowledges (420) the beacon by sending an acknowledgement (ACK) signal via the near-field apparatus, to begin the pairing exchange, and the accessory responds (422) with its capabilities over the near-field link. The data exchange includes transmission (426) from the radio to the accessory instructions to proceed and a RANDOM binary number (which could be, for example, a 128 bit number or a 256 bit number) to be used as a high entropy link key. The accessory responds by transmitting (428) its BDADDR_{accy} and, optionally, an authorization code and/or a cyclic redundancy check (CRC). If the accessory sends the authorization code, the radio checks (430) the authorization code to authenticate the accessory as being trustworthy (a trusted device) and responds by sending (432) the radio's BDADDR_{radio} and, optionally, resource use parameters and/or a CRC. The accessory acknowledges (434) receipt of the data from the radio by sending an ACK signal.

The radio now has the link key it generated and the accessory's BDADDR, and the accessory has the link key and the radio's BDADDR, all exchanged via the near-field apparatus. Each of these devices saves this link key/BDADDR information in pairing tables kept by the respective devices, 436 and 438. Now, from a Bluetooth perspective, these devices are paired and a connection can be formed by a simple Bluetooth paging operation, wherein the paging operation is in accordance with Bluetooth wireless protocol and is well known and will, therefore, not be explained here for the sake of brevity. At this point, the radio and accessory can automatically (without user input) activate their Bluetooth radios for the page/page scan operation (440 and 442) and subsequent link formation and use (444), again in accordance with well known Bluetooth wireless protocol; and the accessory blinks it LED to alert the user that the accessory is ready to use, 446.

After pairing is complete, the page response is quick in Bluetooth (a couple of seconds) and since only the two desired devices (radio and wireless accessory) know the link key, the page is not vulnerable to MITM attack. Also, after pairing is complete, the accessory turns off its beacon transmissions and is no longer receiving in the near-field band. The radio remains (typically) in near-field reception mode so that it may pair additional devices. This means that there are no near-field radiations of any kind after the pairing exchange completes.

Once the link is formed using the near-field transmitted high entropy link key, an encryption key is generated from the link key and encryption is turned on for all links. Since the encryption key is derived from the strong link key, the encryption key is as strong as it can be made and is stronger than a typical Bluetooth encryption key derived from a PIN based link key. As mentioned earlier, the user experience is completely different when using the ultra-low power low frequency near-field system in accordance with the teachings herein. Since the near-field receiver can remain active continuously, when the user brings an accessory within range, a data beacon can be received from the accessory and data exchange begins with no user interaction other than bringing the devices close together. Thus, bringing unpaired devices into close proximity is the user input to begin the pairing. Accordingly, the user experience is fundamentally improved by use of the described ultra-low power near-field apparatus.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and apparatus for the near-field wireless device pairing described herein. The non-processor circuits may include, but are not limited to, a radio receiver, a radio transmitter, signal drivers, clock circuits, power source circuits, and user input devices. As such, these functions may be interpreted as steps of a method to perform the near-field wireless device pairing described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Both the state machine and ASIC are considered herein as a “processing device” for purposes of the foregoing discussion and claim language.

Moreover, an embodiment can be implemented as a computer-readable storage element or medium having computer readable code stored thereon for programming a computer (e.g., comprising a processing device) to perform a method as described and claimed herein. Examples of such computer-readable storage elements include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for near-field wireless device pairing comprising:
at a first communication device comprising radio apparatus for communicating using electromagnetic radio signals:
receiving a beacon from a second communication device, using near-field apparatus, wherein the beacon comprises a pairing request;
in response to receiving the beacon, initiating a pairing procedure, wherein the pairing procedure comprises a data exchange between the first and second communication devices, and wherein the beacon and the data exchange comprise a non-propagating radio signal generated using the near-field apparatus; and
upon completing of the pairing procedure, forming a link for communicating with the second communication device using the radio apparatus.

2. The method of claim 1, wherein the non-propagating radio signal comprises a modulated carrier signal centered at about 125 kHz.

3. The method of claim 1, wherein the beacon is received and the pairing procedure is completed at a distance between the first and second communication devices of no more than six inches.

4. The method of claim 3, wherein the non-propagating radio signal power falls off at a rate of about 1/r⁶, wherein r is a distance between the near-field apparatus in the first communication device and near-field apparatus in the second communication device.

5. The method of claim 1, wherein the non-propagating radio signal consists substantially of a magnetic component.

6. The method of claim 1, wherein the pairing procedure is initiated and completed with the only user input being bringing the first and second communication devices close enough for the first communication device to receive the beacon.

7. The method of claim 1, wherein the data exchange comprises the first communication device sending an internally generated key to the second communication device.

8. The method of claim 7, wherein the internally generated key comprises a 128 bit key or a 256 bit key.

9. The method of claim 1, wherein the beacon is received when the first communication device is powered ON but the radio apparatus is turned OFF.

10. The method of claim 9, wherein the beacon is received when the near-field apparatus is continuously turned ON while the first communication device is powered ON.

11. The method of claim 1, wherein the link is automatically formed without user input upon the completing of the pairing procedure.

12. A method for near-field wireless device pairing comprising:
at a peripheral device comprising radio apparatus for communicating using electromagnetic radio signals:
transmitting a beacon to a host device using near-field apparatus, wherein the beacon comprises a pairing request to initiate a pairing procedure, wherein the only user input needed to initiate the pairing procedure is bringing the peripheral device and the host device close enough for the host device to receive the beacon;
exchanging data with the host device during the pairing procedure using the near-field apparatus, wherein the data is exchanged without user input until completing the pairing procedure; and
upon the completing of the pairing procedure, forming a link for communicating with the host device using the radio apparatus.

13. The method of claim 12, wherein the beacon and the data exchange comprise a non-propagating radio signal.

14. The method of claim 13, wherein the non-propagating radio signal comprises a modulated carrier signal centered at about 125 kHz, and the non-propagating radio signal consists substantially of a magnetic component.

15. The method of claim 12, wherein the peripheral device discontinues transmitting the beacon upon the completing of the pairing procedure.

16. The method of claim 12, wherein the link is automatically formed without user input upon the completing of the pairing procedure.

17. A communication device for near-field wireless device pairing comprising:
radio apparatus that communicates using electromagnetic radio signals;
near-field apparatus that is co-located with the radio apparatus and that communicates a beacon with a second communication device at a distance of no more than six inches from the second communication device, wherein the beacon comprises a non-propagating radio signal, and wherein the beacon comprises a request to initiate a pairing procedure; and
a controller that controls the near-field apparatus to exchange data with the second communication device during the pairing procedure upon a user placing the first and second communication devices close enough for the beacon to be received and without further user input, wherein the data is exchanged using the non-propagating radio signal, wherein upon completion of the pairing procedure the controller controls the radio apparatus to form a link to communicate with the second communication device using the radio apparatus.

18. The communication device of claim 17, wherein the near-field apparatus comprises a coil device that generates the non-propagating radio signal, which consists substantially of a magnetic component.

19. The communication device of claim 17, wherein the link to communicate with the second communication device using the radio apparatus is formed using Bluetooth wireless protocol.
